(19) United States
(12) Patent Application Publication
(10) Pub. No.: US 2008/0184899 A1
(43) Pub. Date: Aug. 7, 2008

(54) SELF PRESSURIZING SHELF LIFE EXTENDER FOR FOOD AND METHOD

(76) Inventors: David Richmond, Beverly Hills, CA (US); Jonathan Oswaks, Westlake Village, CA (US)

Correspondence Address: ELIZABETH SWANSON;c/o SWANSON & ASSOCIATES, 9454 WILSHIRE BLVD., SUITE 500, BEVERLY HILLS, CA, 90212, US

(21) Appl. No.: 12/028,006

(22) Filed: Feb. 7, 2008

Related U.S. Application Data
(60) Provisional application No. 60/888,553, filed on Feb. 7, 2007.

(51) Int. Cl. B65D 81/20; A23L 3/015; B65D 43/00

(52) U.S. Cl. 99/472; 426/665; 220/212

(57) ABSTRACT

The present disclosure comprises both a self-pressurizing food storage device and method of use. The device defines and presents an enclosed food storage chamber composing an internal air pressure of about 1 psi to about 10 psi above ambient air pressure outside the chamber by providing a geometrically and ergonomically comfortable lid assembly, a food container adapted to mate with the lid assembly, and means for closingly mating them together. No external, detachable pump is required to create the elevated pressure within the food containing chamber.

### RELATED APPLICATIONS

This application claims its priority of filing date from U.S. Provisional Application No. 60/888,553 entitled SELF PRESSURIZING SHELF LIFE EXTENDER FOR FOOD filed on Feb. 7, 2007 in the United States Patent and Trademark Office.

### BACKGROUND

Common food preservation methods and devices inactivate pathogens and chemicals that cause the food to decay. These include irradiating, drying, canning, heating, pickling, freezing or refrigerating food. Some fresh foods maintain freshness longer by being contained within either an air-tight or an airless container, or by being stored in a container that removes ripening gases, such as ethylene, produced by the food itself. Carbonated beverages are “preserved” by being maintained under air pressure to ensure that the gasses remain in solution until the beverage is consumed. Finally, some foods are preserved by maintaining them under an atmosphere other than ambient air, such as under nitrogen or carbon dioxide.

Less popular food storage methods and devices include those that subject food to high atmospheric air pressure for varying lengths of time. These methods and devices subject food to atmospheric pressure from about 100-500 pounds per square inch (“psi”) for varying lengths of time.

Each of the preservation methods or devices above may change or compromise the original texture and flavor of the foods preserved, especially of fresh fruits and vegetables. They also require significant energy energy input. This is especially true for high pressure preservation methods and devices, which are typically used only by factories or manufacturing facilities.

Recent data suggest that the relatively low pressure of an atmosphere of ambient air, pressurized to about 1 psi to about 10 psi above ambient air pressure, will extend the shelf life of certain foods. Under such low pressure storage conditions, food is not “preserved” for long periods of time, but the shelf life is extended. The texture, color and flavor are largely retained as they are found in the food before low pressure storage. The mechanism of action of low pressure storage is not well known, but it has been proposed that the pressure inhibits the action of pathogens, or that it slows the speed with which the food itself produces agents that contribute to decay.

Despite some knowledge of the efficacy of low pressure food storage, no consumer device or method currently exist for extending food shelf life under low pressure that does not require detachment after pressurization of an external pump. The U.S. Pat. No. 5,031,785 by Lemme, COMBINATION VACUUM/PRESSURE PUMP AND VALVE STOPPER FOR FOOD OR DRINK CONTAINERS, provides an example of a device using a detachable pump. No self-pressurizing device or method for extending the shelf life of food by storage of food under relatively low pressure has been disclosed heretofore.

Using a separate and detachable pump is cumbersome, and requires having the pump with you whenever you wish to open the container of stored food, remove a portion of the food to consume, and reseal the remaining food under low pressure. As in the '785 patent by Lemme, use of such a device requires attachment of the pump to a specially adapted valve stopper that mates with the pump, manipulating the pump by sliding the handle of the pump relative to the pump cylinder a sufficient number of times to create a desired vacuum or pressure, and then removing the pump from the valve for storage and future use. This entails several steps which a hungry consumer may not be eager to take.

Indeed, the majority of food storage products on the market teach away from the device and method of the instant invention. Some popular containers encourage the consumer to push excess air out of the container by “burping” and then sealing the lid, inducing a vacuum. This is directly contrary to the device and method of the disclosure herein.

For ergonomic and comfortable consumer use, to increase the shelf life of food without requiring external energy input, and to provide this while maintaining a relatively low cost of manufacture, there is a need for a self pressurizing food storage device and method that enables a consumer to store food within an enclosed chamber having an internal air pressure about 1 psi to about 10 psi above external ambient air pressure, and that requires no separate pump or other device to generate such pressurize.

The disclosed device and method of use disclosed herein support ecological balance and help the environment generally. They require no use of electricity or motor, but instead provide an elegant device that creates a new way to manually create additional pressure of about 1 psi to about 10 psi over ambient air pressure inside the food container.

No attached pumps or other devices must be used to create the pressure needed. The geometries of the parts of the device and the method of use thereof provides an ergonomically correct and comfortable to use device. The user provides all pressure needed to enclose the food in the disclosed device, and to use the method therefor.

Increasing the shelf life of food decreases wasted food, such as seasonal produce which may decay faster than the consumer is able to finish the produce purchased, and so provides additional environmental benefits.

### BRIEF DESCRIPTION

The present disclosure comprises both a self-pressurizing food storage device and method of use. The device defines and presents an enclosed food storage chamber composing an internal air pressure of about 1 psi to about 10 psi above ambient air pressure outside the chamber by providing a geometrically and ergonomically comfortable lid assembly, a food container adapted to mate with the lid assembly, and means for closingly mating them together. No external, detachable pump is required to create the elevated pressure within the food containing chamber.

One exemplary embodiment of the device comprises a food container that partially defines a container air space, a lid assembly which partially defines a lid air space, which lid assembly is adapted to sealingly close and mate with the container. The container and lid assembly are adapted to define an airtight chamber when the lid assembly is positioned over the food container in a first position. In this first position, air from the lid air space and air from the container air space may become commingled within the chamber, but are sealingly enclosed there within. In the first position, the commingled air is at about ambient pressure.

According to the method of the disclosure, and using embodiments of the device described herein, the lid assembly is moved from its first position to a second position in which the lid assembly at least partially overlaps the container. At this second position, air within the chamber is pressurized to about 1 psi to about 10 psi above ambient pressure outside the chamber because the volume of the air within the chamber decreases while its mass remains the same. After positioning the lid assembly in its second position, this second position is maintained by a closure assembly.

Closure assemblies according to the disclosure may comprise at least one: bayonet closure, over-center latch, pivotally attached lever, or some other closure assembly known in the art. Closure assembly is geometrically configured to provide sufficient leverage to enable a consumer to urge the lid assembly into its second position ergonomically and manually, and to thereby create an internal air pressure within a pressurized chamber according to this disclosure of about 1 psi to about 10 psi over external ambient pressure.

Proper pressure within the device is maintained in at least one exemplary embodiment that comprises a valve assembly positioned in the lid assembly.

In an exemplary embodiment, the device and method comprise a potassium permanganate impregnated zeolite within the food container, which zeolite absorbs ethylene gas produced by the contained food. Some produce, such as bananas, naturally produce ethylene, which gas quickens the ripening and then the decay of the fruit. Removal of ethylene in combination with low pressure lengthens the shelf life of foods that emit ethylene.

### DRAWINGS

FIG. 1 is an exploded perspective view of an exemplary embodiment of a device of the disclosure;

FIG. 2 provides three views of an exemplary method of use of the disclosures;

FIG. 3A is a perspective view of an exemplary embodiment of a device of the disclosure;

FIG. 3B is a top plan view of an exemplary embodiment of a device of the disclosure;

FIG. 3C is a side elevation view of an exemplary embodiment of a device of the disclosure;

FIG. 3D is a sectional view of a device of an exemplary embodiment viewed along the axis defined in FIG. 3C;

FIG. 4A is a side elevation view of an embodiment of an exemplary device of the disclosure;

FIG. 4B is a side sectional view of an embodiment as shown in FIG. 4A of an exemplary device of the disclosure.

FIG. 5 is a partial sectional view of an exemplary embodiment of a device of the disclosure;

FIG. 6 is a partial sectional view of an exemplary embodiment of a device of the disclosure;

FIG. 7 provides three partial side sectional views of an exemplary embodiment of a device of the disclosure;

FIG. 8A is a top plan view of an exemplary embodiment of a device of the disclosure;

FIG. 8B is a side sectional elevation of an exemplary embodiment of a device of the disclosure; and

FIG. 8C is a side sectional elevation of an exemplary embodiment of a device of the disclosure.

### DETAILED DESCRIPTION

A device and method of use therefor of extending the shelf life of food comprising an airtight food storage chamber of formerly ambient air pressurized to about 1 to about 10 pounds per square inch above ambient pressure, the chamber defined by closingly mating a food container and a lid assembly, wherein the ambient air therein is pressurized by moving the lid assembly relative to the container from a first position to a second and mated position.

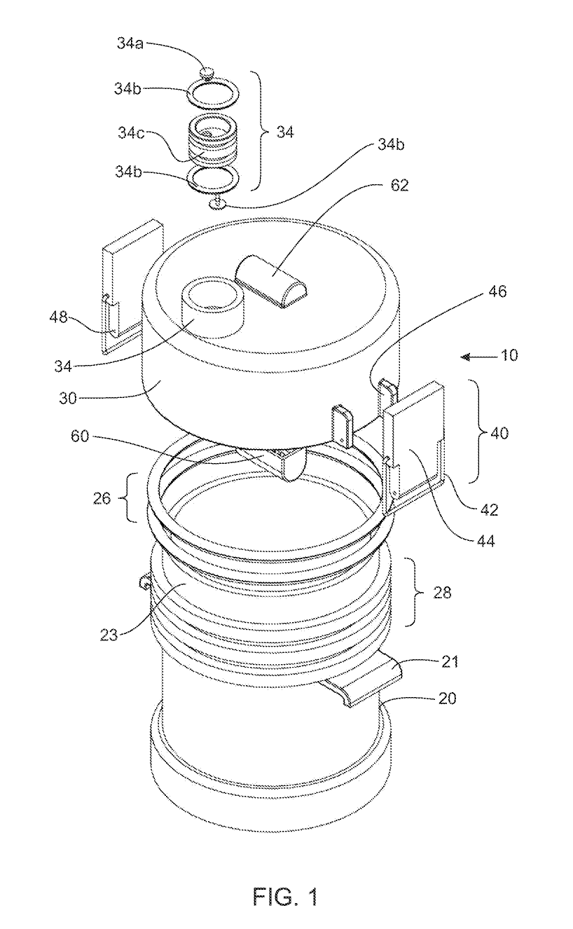

An exemplary embodiment of the device 10 is illustrated at FIG. 1. FIG. 1 discloses a food container 20, a lid assembly 30, at least one closure assembly 40, a valve assembly 34, a zeolite holder 60 and zeolite viewing window 92, and at least one seal 26 mounted on at least one rim 28 of the container 20.

Valve assembly 34 comprises at least one valve 34a, FIG. 1, calibrated to release pressure from within the compressed air space 52 should that pressure exceed about 10 psi. Increased pressure may result from, for example, food 22 within container 20 creating gasses or causing production of gas creating agent.

Valve assembly 34 can be calibrated to a smaller range of pressures within the possible range of about 1 psi to about 10 psi, depending on optimum storage pressure for one or more types of food being stored.

Valve assembly 34 may comprise at least one valve configured to release vacuum created within chamber 50, 52 when device 10 is opened, namely when lid assembly 30 is moved from its second position to its first position, and then removed from contact with food container 20. As in FIG. 1, mushroom valve 34a is adapted to release excess pressure within chamber 52, while mushroom valve 34b is adapted to release any vacuum formed when lid assembly 30 is being moved apart from food container 20.

Referencing an exemplary embodiment of FIG. 1, closure assembly 40 illustrated therein comprises a pair of levers 44, catch rings 42 mounted thereon, lever arms 46 adapted to hingedly attach levers 44, and catch arms 21 over which catch rings 42 fit and under which catch rings 42 latch. Closure assembly 40 is configured to urge and move lid assembly 30 from its first position to its second position, when manipulated by a user, thereby creating a low pressure food storage chamber 52. The length of levers 44 may vary depending upon the amount of mechanical leverage required to ergonomically and easily achieve lid assembly 30 second position. These closure assemblies may, in exemplary embodiments, be adapted to reversibly latch lid assembly 30 in its second position.

The lid assembly 30 and food container 20 in this and other exemplary embodiments disclosed herein are geometrically configured to create air pressure from about 1 psi to about 10 psi within chamber 50, 52 without the use of an external pump.

Lid assembly 30 and container 20 are geometrically proportioned to generate from about 1 psi to about 10 psi over ambient air pressure when lid assembly 30 comprises its second position. Should particular foods have optimum storage pressure of 3 psi above ambient pressure, for example, the volume of chamber 50 may be adapted to permit a user to move lid assembly 30 from a first to a second position without use of a separate or removable device. Such closure assembly may also comprise a bayonet closure (not shown). In a preferred embodiment comprising a bayonet closure, the rotation of the lid assembly 30 relative to the food container 20 is less than 360 degrees of rotation.

In an exemplary embodiment, optimal chamber pressure is from about 1 psi to about 10 psi above ambient pressure. In another exemplary embodiment, optimal chamber 52 pressure is from about 3 psi to about 5 psi above ambient pressure. To achieve different ambient pressures or ranges, valves with different cracking pressures may comprise valve assembly 34.

Certain fresh foods, for example bananas, naturally produce ethylene, which gas quickens the ripening and then the decay of the fruit. Removal of ethylene from a storage container using zeolite, in combination with low pressure storage, further lengthens the shelf life of foods that emit ethylene.

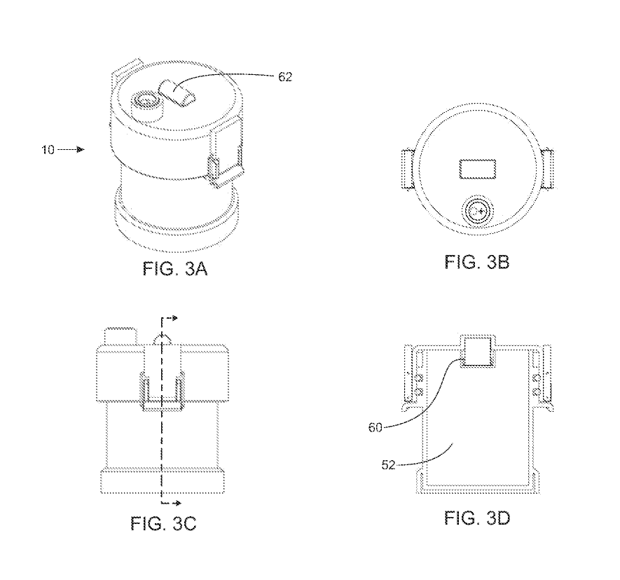

In an exemplary embodiment illustrated in FIGS. 1 and 3, the device and method comprise a potassium permanganate impregnated zeolite within food container 50 that absorbs ethylene gas produced by the contained food. Zeolite is provided in a sachet (not shown) comprising an air and water vapor permeable membrane. The sachet may be suspended within pressurized chamber 52 from zeolite holder 90. Holder 90 is removeable, so that zeolite sachets may be replaced as necessary.

Zeolite impregnated with potassium permanganate is a purple or lavender color when it is “fresh” or able to absorb ethylene, but turns brown when it is ethylene saturated. A user might therefore prefer knowing whether a fresh sachet needs to replace a saturated one, and may determine the status of the zeolite absorbing capacity while device of the disclosure 10 is in use. Transparent window 62 is positioned in lid assembly 30 to enable a user to view the color of the zeolite sachet from outside storage device 10. To replace a sachet, the user may then open device 10, replace a used zeolite sachet with a new one, then repressurize device 10.

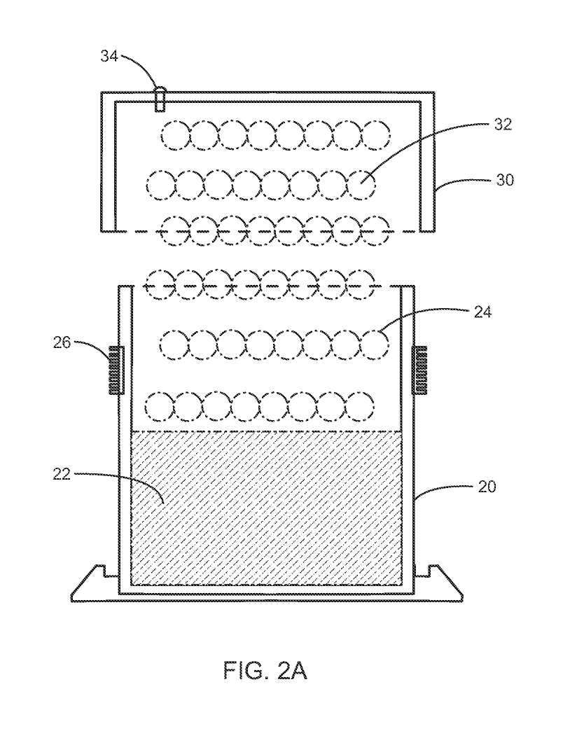

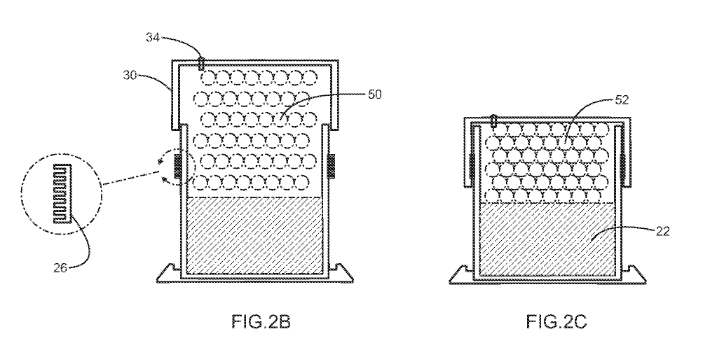

An exemplary embodiment of the method of using the device is illustrated at FIG. 2. In FIG. 2A, the food container 20 holds food to be stored that was previously placed in the container 22 (food not claimed, included for illustrative purposes only) and ambient pressured air present in a partially defined container air space 24. The lid assembly 30 comprises a partially defined lid air space 32 in which air is at ambient pressure.

After food is placed in the container 20, the lid assembly 30 and container 20 are arranged in a first position, as illustrated at FIG. 2B, and now comprise a combined air space 50. At this first position, air within the air space 50 is at about ambient air pressure.

In FIG. 2C, lid assembly 30 is then closingly mated with the container 20, thereby changing the volume of the air space to a compressed air space 52. The air within the compressed air space 52 thereby becomes pressurized to about 1 psi to about 10 psi above ambient pressure. As one exemplary embodiment of the geometrical proportions of lid assembly 30 to container 20 should a desired pressure within the chamber 52 comprise about 3 psi above ambient pressure, lid assembly 30 is adapted to comprise lid air space of about 15-20% of container air space 32.

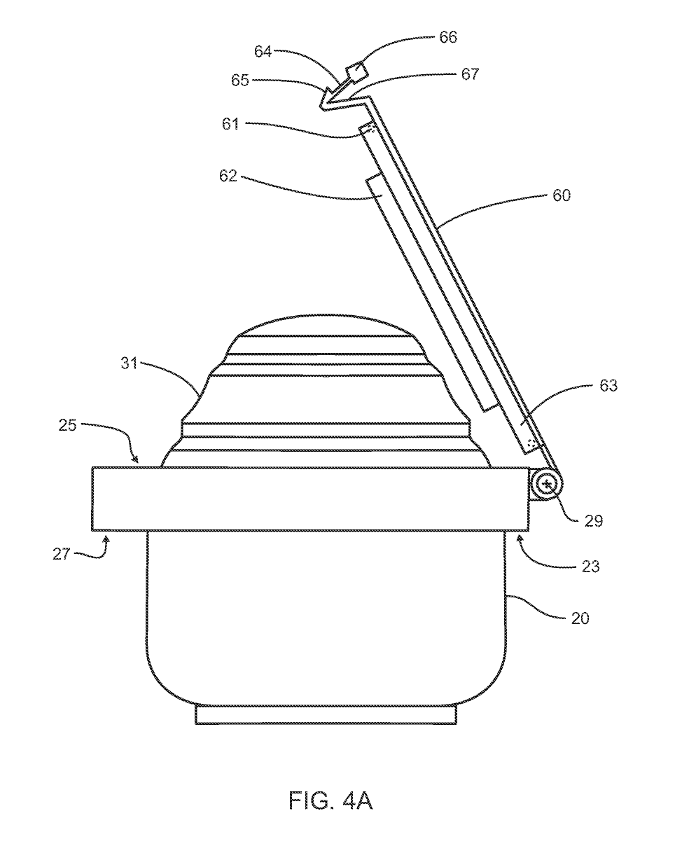

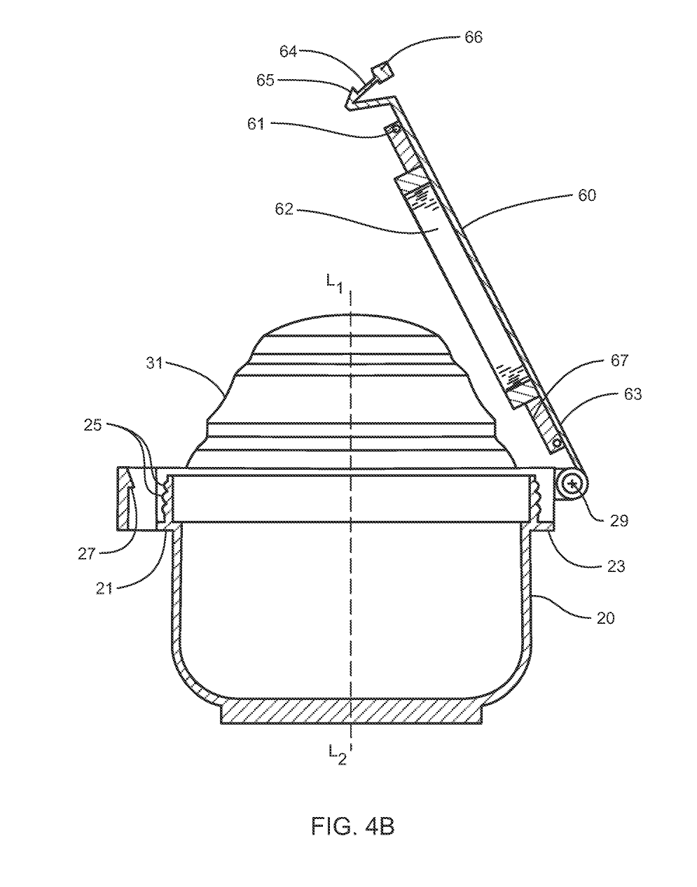

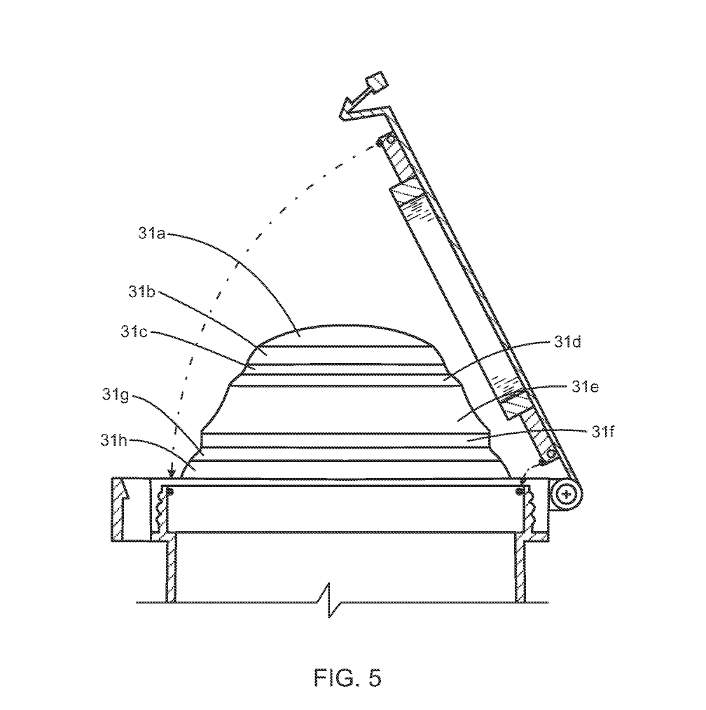

In another exemplary embodiment of the invention, FIGS. 4 and 5, the lid assembly comprises at least flexible bellows 31. Lid bellows 31 may comprise domed section 31a; annular convex portions 31b, 31h; annular concave portions 31c, 31e, 31g; annular cone portion 31d; and cylindrical portion 31f. The centers of lid bellows portions 31a through 31h, inclusive, line up along a common center line L₁-L₂. Domed section 31a has a the smallest radius of the portions of bellows 31. Remaining portions, 31b, 31c, 31d, 31e, 31f, and 31g, each have incrementally larger radii, with annular convex portion 31h comprising the largest radius of bellows 31.

When bellows 31 is in its first or extended position, FIGS. 4A and 4B, bellows portions 31a-31h may be said to be oriented “up.” When bellows 31 is compressed into its second position, FIG. 4C, annular bellows portions 31a-31h are configured and adapted to fold in on each other in a modified “accordian” until bellows 31 is in its second position. When bellows 31 is fully compressed in its second position, some of bellows 31 portions remain in their “up” configuration, namely 31a, 31b, 31c, 31d, 31g and 31h, while remaining bellows portions, 31e and 31g, become oriented “down” relative to their original position. Areas of connection between each of bellows portions 31a-31h are functionally living hinges.

The specific pattern of bellows portion folding may vary between embodiments, depending upon the degree of pressure within the chamber desired. A smaller volume 52 results when a greater number of bellows 31 portions become oriented “down” in the lid assembly's second or compressed position.

By virtue of common alignment center along line L₁-L₂, sequentially sized radii, lid bellows portions 31 are configured to fold in a vertical line L₁-L₂ that includes the center of each portion 31a through 31h, inclusive, when a pivotally attached arm 60 is moved from its open, first position to its latched, second position.

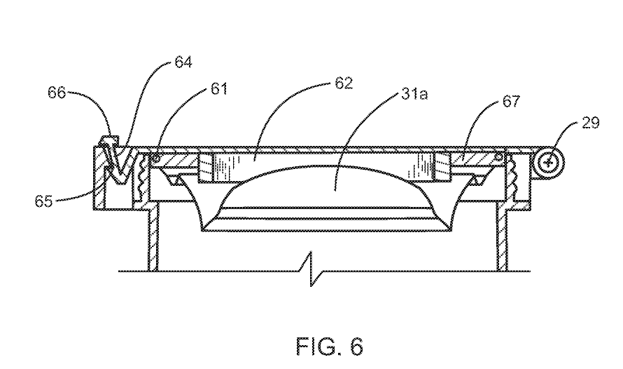

Bellows 31 comprises a first, extended position, wherein portions 31a through 31h, inclusive, are “up”. Pressurization of air within chamber 50 may be effected by collapsing bellows 31 to its second position. Such collapse may result from a user moving a hinged lever arm 60 from first position, FIG. 5, to second position, FIG. 6.

Hinged arm 60, FIGS. 4, 5 and 6, comprises arm bar 63, inner push rim 62, outer insert rim 67, latch keeper 65, tab arm 64 and tab 66. Arm 60 is attached by hinge 29 to bellows lid assembly 31 in one or more embodiments illustrated, but may be hingedly attached to container 20 instead. Outer insert rim 67 may comprise at least one stabilizer member 61, shown in cross-section at FIGS. 4B and 4C (as open circles). The at least one stabilizer member 61 may comprise one or more connected loops or a plurality of discontinuous stabilizing members of the insert rim 67.

According to an exemplary method of the disclosure, a user moves hinged arm 60 from its first position, FIG. 5, to its second position, FIG. 6. When the hinged arm 60 is positioned at its first position, the lid bellows 31 is also positioned at its first position. Similarly when the hinged arm 60 is moved to its second position, the lid bellows 31 is compressed into its second position, FIG. 6.

When a user moves the arm 60 from its first to second position, inner rim 62 partially entraps and encloses lid bellows portion 31a, and thereby maintains collapse of bellows 31 within container rim 21. At least one hinge attaching arm 60 to lid assembly 30 may comprise any hinge known and used in the art, such as for example, a living hinge.

The amount of force a user must exert to move lid assembly to its second position is proportional to the amount of pressure desired inside the chamber 50 and the size and dimensions of the chamber 52. The geometry of closure assembly employed in an exemplary embodiment of the device 10 may depend therefrom. For smaller containers, a bayonet closure or over center latch assembly works easily as a closure assembly. For larger containers, closure assembly 40 that employs lever arm 44 attached to container 20 by hinge 29 may be preferred.

In a still further exemplary embodiment, a lever that compresses the bellows may be completely separate from any closure that maintains the lid assembly in its second position relative to the container. A latch assembly adapted to maintain a lid assembly may be independent of any lever assembly or closure assembly.

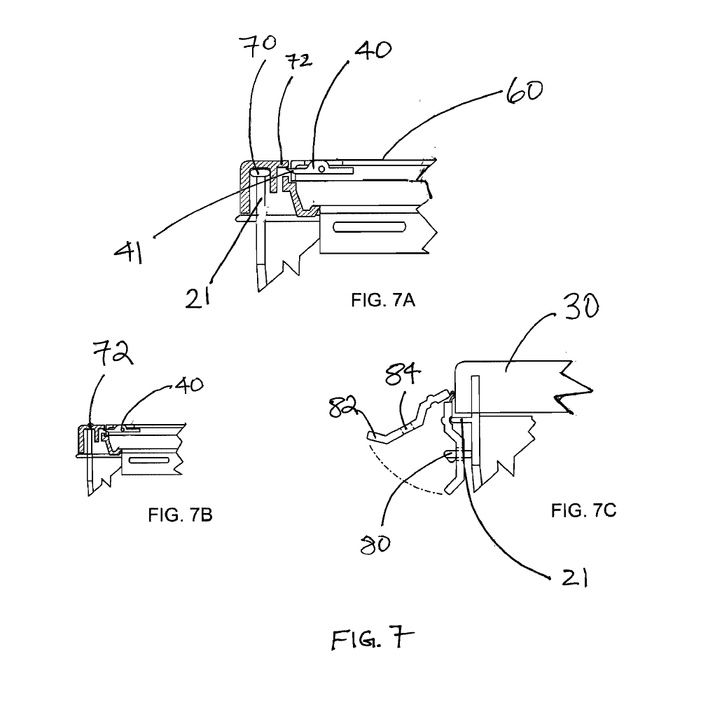

Referring now to FIG. 7, where are illustrated embodiments of exemplary, but not limiting, latch assemblies of device 10. FIG. 7A illustrates lever arm 60 comprising an inset, slidable latch 40. Leading edge 41 of latch 40 is angled to catch under rim 72. Latch 40 is slidably disposed within or upon arm 60, and a user may engage or disengage leading edge 41 with rim 72. Further illustrated is compressible seal 70 mounted on rim 21.

FIG. 7B illustrates a cross section of at least one stabilizing member 72 of rim 72.

FIG. 7C illustrates hinged latch 82 hingedly attached to a lid assembly 30. An aperture 84 defined by latch 82 captures keeper 80 when latch 82 is positioned thereupon, the keeper 80 extending outwardly from rim 21 through aperture 84.

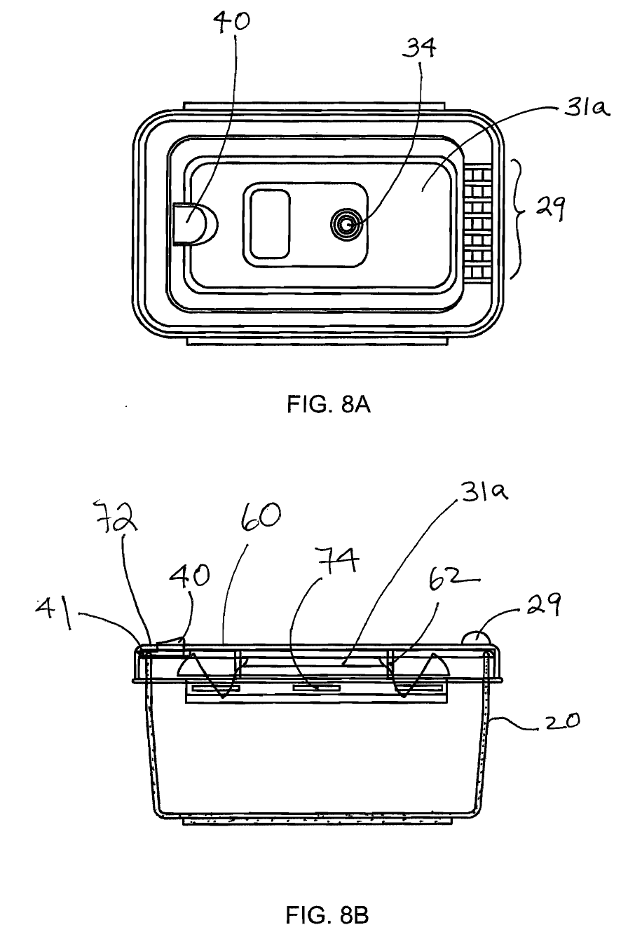

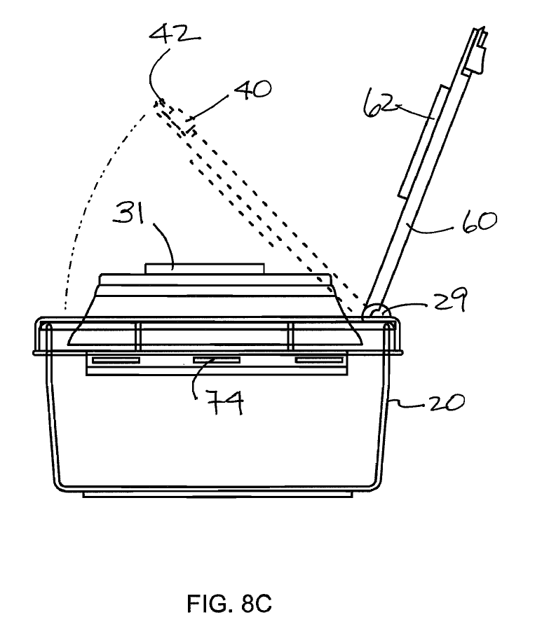

An exemplary embodiment is illustrated in FIG. 8 of a non-round device 10. FIG. 7A illustrates exemplary members comprising a bellows assembly 31. As illustrated in FIG. 7B, slidable closure assembly 40 is adapted for catching leading edge 41 under rim 72. A zeolite viewing window (not shown) may comprise the bellows lid assembly 31. Closure assembly 40 may be slidingly disposed upon top bellows portion 31a of bellows lid assembly 31, or may be disposed upon a lever arm 60.

FIG. 8B illustrates at least one snap fit tab and slot assembly 74 adapted to latch top assembly 31 to food container 20.

FIG. 8C illustrates hinged lever assembly 60 comprising at least one inner push rim 62 adapted to capture top bellows portion 31a. While FIG. 8 illustrates one non-round embodiment of device 10, the methods of compressing the lid bellows assembly 31 by closure assembly 60 are identical.

While the device and method of exemplary embodiments have been illustrated and described in what are considered to be practical and preferred embodiments, it will be recognized that many variations are possible and come within the scope thereof. The appended claims therefore being entitled to a full range of equivalents.

We claim:

1. A device for extending the shelf life of food comprising an airtight food storage chamber of formerly ambient air pressurized to about 1 to about 10 pounds per square inch, the chamber defined by mating a food container and a lid assembly, wherein the ambient air is pressurized by urging the container and assembly toward one another into a mated position.

2. The device of claim 1 wherein the container and lid assembly comprise at least one locking assembly adapted to urge the container and lid assembly into their mated position and to lock them in the mated position.

3. The device of claim 1 wherein the air within the chamber is defined and becomes pressurized by rotating the lid assembly rotatably relative to the container, said rotation of the lid assembly relative the container comprising no more than 360 degrees of rotation.

4. The device of claim 1 wherein the container further comprises a potassium permanganate impregnated zeolite packet comprising an air and ethylene permeable membrane.

5. A device for extending the shelf life of food comprising: a food container and a lid assembly adapted to matingly define an air tight foode storage chamber and, by mating, to pressurize air within the defined chamber from its ambient pressure to an air pressure of about 1 to about 10 pounds per square inch, a valve assembly adapted to maintain the chamber at a pressure of about 1 to about 10 pounds per square inch, and at least one latch assembly adapted to maintain the food container and lid assembly in their mated position.

6. The device of claim 5, wherein:
a. the lid assembly comprises a first surface, a second surface, a rim, the valve assembly, the zeolite holder, and the at least one pair of latch assemblies;
b. the zeolite holder comprising a zeolite basket adapted to removably maintain a zeolite containing, air and ethylene permeable packet proximate the second surface of the lid, the basket further adapted to permit pressurized air to contact the packet and zeolite therewithin;
c. the valve assembly adapted to extend through the first and second surface of the lid assembly;
d. the at least one pair of latch assemblies mounted on opposite sides of the rim; and
e. the container further comprising an exterior and at least a pair of latch keepers mounted on the exterior adapted to latch with the at least one lid-mounted pair of latch assemblies.

7. The device according to claim 5, wherein the container comprises an exterior surface and an upper rim, and at least one seal is mounted between at least a pair of ridges extending outwardly from the surface, said ridges extending in a plane substantially parallel to the upper rim.

8. The device according to claim 5, wherein the valve assembly comprises at least one pressure release valve.

9. A device and method of use for extending the shelf life of food comprising placing the food in a food container adapted to form an airtight chamber when the container is mated to a lid assembly, mating the lid assembly and container, and by this mating, increasing the pressure of air trapped within the chamber to about 1 to about 10 pounds per square inch, and latching the lid assembly and container in their mated position, thereby containing the food within the pressurized chamber, said pressurization effecting an extension of the shelf life of the contained food.

10. A method of extending the shelf life of food and preserving its freshness comprising enclosing the food in an air tight container assembly, the airtight container assembly comprising a lid assembly and food container adapted to pressurize ambient air trapped within a space defined therebetween to about 1 to about 10 pounds per square inch by mating the lid assembly and food container.

11. A method of extending the shelf life of food and preserving its freshness comprising enclosing the food in an air tight container assembly with an air and ethylene permeable packet of zeolite impregnated with potassium permanganate, the airtight container assembly comprising a lid and container adapted to pressurize air trapped within a space defined by the lid and container to about 1 to about 10 pounds per square inch.

12. A food shelf-life extending device, comprising:
a. a lid assembly comprising at least a bellows, the bellows comprising at least an extended bellows position and a compressed bellows position;
b. a food container configured to sealingly enclose ambiently pressured air within a chamber, the chamber defined by mating the lid assembly with the food container; and
c. the chamber further comprising air enclosed therewithin that becomes pressurized from its ambient pressure to about 1 to about 10 pounds per square inch by moving the bellows from the extended position to the compressed position.

13. The device according to claim 12 wherein the food container and lid assembly, when in their mated configuration, comprise at least one lever assembly adapted to urge the bellows from at least one extended position to at least one compressed position while air is enclosed within the chamber.

14. The device according to claim 12 wherein the food container comprises at least one hinged lever adapted to urge the bellows from at least one extended position to at least one compressed position while air is enclosed within the chamber.

15. The device according to claim 12 wherein the lid assembly comprises at least one hinged lever adapted to urge the bellows from at least one extended position to at least one compressed position while air is enclosed within the chamber.

16. The device according to claim 12 wherein the lid assembly comprises at least one latch adapted to maintain the chamber.

17. The device according to claim 12 wherein the the lid assembly snap fits onto the container.

18. The device according to claim 12 wherein the airtight chamber comprises at least one seal.

19. The device according to claim 12 wherein the chamber further comprises a potassium permanganate impregnated zeolite packet comprising an air and ethylene permeable membrane.

20. A device, comprising:
a. a food container and a lid assembly adapted to mate and to define an air tight chamber;
b. the lid assembly comprising a non-removable manually operated air compressor;
c. the air compressor comprising a first position and a second position;
d. the air tight chamber comprising ambient air while the compressor is configured in its first position;
e. the air tight chamber comprising air of about 1 to about 10 pounds per square inch while the air compressor is configured in its second position; and
f. at least one valve adapted to permit air to exit the chamber while the air compressor is moved from its first to its second position.

21. The device according to claim 20, wherein the air compressor comprises at least one bellows.

22. The device according to claim 20, wherein the device further comprises a lock adapted to maintain the lid and container in their mated position.

23. The device according to claim 20, wherein the device further comprises at least one latch assembly adapted to latch the lid and container together in their mated position.

24. The device according to claim 20, wherein the air compressor comprises a lock adapted to lock the air compressor in its second position.

25. The device according to claim 20, wherein the device comprises potassium permanganate impregnated zeolite packet comprising an air and ethylene permeable membrane.
